(19) United States
(12) Patent Application Publication
(10) Pub. No.: US 2016/0261821 A1
(43) Pub. Date: Sep. 8, 2016

(54) TELEVISION BOX

(71) Applicants: BOE TECHNOLOGY GROUP CO., LTD., Beijing (CN); BEIJING BOE MULTIMEDIA TECHNOLOGY CO., LTD, Beijing (CN)

(72) Inventors: Yansheng Sun, Beijing (CN); Huijun Li, Beijing (CN); Xinhua Jia, Beijing (CN)

(21) Appl. No.: 14/785,825

(22) PCT Filed: Mar. 18, 2015
(86) PCT No.: PCT/CN2015/074454

§ 371 Date: Oct. 20, 2015

(30) Foreign Application Priority Data
Oct. 30, 2014 (CN) 201420642401.2

(51) Int. Cl. H04N 5/64

(52) U.S. Cl. CPC H04N 5/64

(57) ABSTRACT

The present disclosure provides a television box. The television box comprises: a tubular outer housing which has an opening at one end thereof and defines a receiving chamber therein; and a slide assembly which comprises an electronic component board and is sidably received in the receiving chamber of the tubular outer housing through the opening. In the television box, the tubular outer housing has an integrated structure, the slide assembly comprising the electronic component board is slidably received in the receiving chamber of the tubular outer housing, so that the supporting strength of the entire television box is increased and the aesthetic appearance of the television box is improved.

### BACKGROUND OF THE INVENTION

1. Field of the Invention

The disclosure relates to a television box for controlling the television broadcast.

2. Description of the Related Art

At present, an outer housing of a television box is usually made of two pieces (separable parts), in which a circuit board card is attached to a bottom cover, after a front end cover and a rear end cover are assembled, a bottom cover assembly (including the board card and the bottom cover) is assembled with the outer housing. In that case, a seam between the bottom cover and the outer housing is visible on the external appearance, as shown in FIGS. 1 and 2. A method of assembling the existing television box comprises: mounting a circuit board card 2 on a bottom cover 3; assembling an end cover with an outer housing 1; mounting a bottom assembly assembled with the circuit board card 2 on the outer housing 1 with screws. There are following defects in the existing assembled television box: the entire housing has a poor supporting strength because the entire housing consists of the outer housing and the bottom cover, and it is not aesthetically attractive as there is an assembling seam which is visible on the appearance of the television box.

### SUMMARY OF THE INVENTION

The present disclosure provides a television box so as to improve the supporting strength and/or aesthetic appearance of the television box.

The present disclosure provides a television box comprising:

a tubular outer housing which has an opening at one end thereof and defines a receiving chamber therein; and

a slide assembly which comprises an electronic component board and is sidably received in the receiving chamber of the tubular outer housing through the opening.

In the television box, the tubular outer housing has an integrally formed structure, the formed outer housing has a receiving chamber, the slide assembly has an electronic component board and is slidably received in the receiving chamber of the tubular outer housing. With the integrated structure of the outer housing, the supporting strength of the entire television box is increased and the aesthetic appearance of the television box is improved.

According to an embodiment, the slide assembly further comprises: a supporting assembly which is slidably connected with a sidewall of the tubular outer housing, the electronic component board being fixed on the supporting assembly; and an end cover which is fixed on the supporting assembly and used for covering the opening of the tubular outer housing.

According to an embodiment, a positioning groove is provided in the sidewall of the tubular outer housing and a positioning protrusion which slidably engages the positioning groove is provided on the supporting assembly; or

a positioning protrusion is provided on the sidewall of the tubular outer housing and a positioning groove which slidably engages the positioning protrusion is provided in the supporting assembly.

Accordingly, the stability of the supporting assembly when sliding is increased.

According to an embodiment, the supporting assembly comprises two slide rails which are arranged opposite to each other. The electronic component board is supported by the slide rails.

According to an embodiment, positioning protrusions are provided on the sidewall of the tubular outer housing and positioning grooves which slidably engages the positioning protrusions are provided in the two slide rails, respectively; or

positioning grooves are provided in the sidewall of the tubular outer housing and positioning protrusions which slidably engages the positioning grooves are provided on the two slide rails, respectively.

accordingly, the stability of the supporting assembly when sliding is thus increased.

According to an embodiment, the slide rail has an L-shape structure comprising a first folding part and a second folding part, and Two sides of the electronic component board are fixed on the first folding parts of the two slide rails, respectively. Thus, the slide rail has a stronger supporting capacity by using the L-shape structure.

According to an embodiment, the positioning grooves or the positioning protrusions are provided in or on the first folding parts or the second folding parts of the two slide rails, respectively.

According to an embodiment, the first folding part of the slide rail is fixedly connected with the electronic component board in a snap-fit manner. Thus, it facilitates to connect the electronic component board and the slide rail.

According to an embodiment, the first folding part of the slide rail is fixedly connected with the electronic component board through an individual connecting device. Thus, it has better connecting stability.

According to an embodiment, the supporting assembly is fixedly connected with the outer housing through a connecting member when the end cover covers the opening of the receiving chamber. The stability of the electronic component board in the assembled television box is thus increased.

According to an embodiment, the connecting member is a bolt or screw; the outer housing is provided with a stepped hole for passing the bolt or screw, the supporting assembly is provided with a threaded hole matching the stepped hole, and a portion of the stepped hole having larger diameter is located on an outer side of the outer housing;

the outer housing is fixedly connected with the supporting assembly by engaging the bolt or screw passing through the stepped hole with the threaded hole and a cap of the bolt or screw is located in the portion of the stepped hole having a larger diameter when the supporting assembly slides to a predefined position.

According to an embodiment, an antislip pad is provided in each stepped hole and covers the cap. The stability of the television box when being placed is thus increased.

According to an embodiment, a stopper is provided on the tubular outer housing, and the stopper prevents the slide assembly from sliding further when the slide assembly has slid to the predefined position.

According to an embodiment, the tubular outer housing has another opening at the other end thereof for mounting another end cover.

### BRIEF DESCRIPTION OF THE DRAWINGS

FIG. 1 is an exploded schematic view of an existing television box;

FIG. 2 is a schematic structural view of the existing television box in FIG. 1 which is assembled;

FIG. 3 is an exploded schematic view of a television box according to an embodiment of the present invention;

FIG. 4 is a schematic view of the television box of FIG. 3 which is being assembled;

FIG. 5 is a schematic view of the television box of FIG. 4 which has been assembled;

FIG. 6 is a schematic structural view of an outer housing according to an embodiment of the present invention;

FIG. 7 is a schematic view of a slide assembly which is to be assembled with the outer housing in FIG. 6;

FIG. 8 is a schematic structural view of an outer housing according to another embodiment of the present invention; and

FIG. 9 is a schematic view of a slide assembly which is to be assembled with the outer housing in FIG. 8.

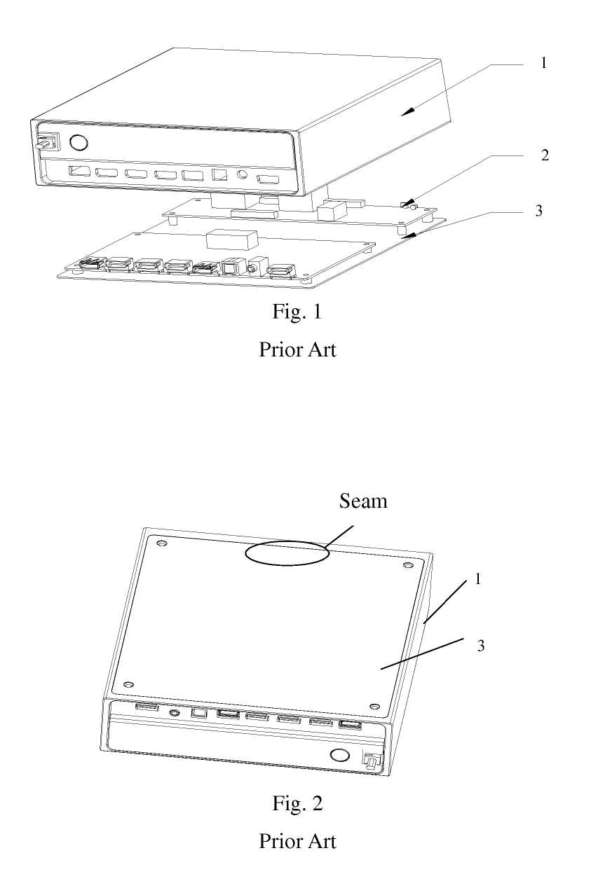

### LIST OF REFERENCE NUMERALS

1—outer housing;
2—circuit board card;
3—bottom cover;
10—outer housing;
11—receiving chamber;
12—positioning protrusion;
13—positioning groove;
20—slide assembly;
21—supporting assembly;
21a—slide rail;
21b—slide rail;
211—first folding part;
2111—positioning groove;
2112—positioning protrusion;
212—second folding part;
22—electronic component board;
30—rear end cover;
40—antislip pad.

### DETAILED DESCRIPTION OF PREFERRED EMBODIMENTS OF THE INVENTION

Embodiments of the present invention provide a television box, in which the supporting strength of the television box is increased by an integrated outer housing and a slide assembly connected slidably with the outer housing. In order to make the objectives, solutions and advantages of the present invention more clear, the present invention will be further described in details by the following non-limiting embodiments.

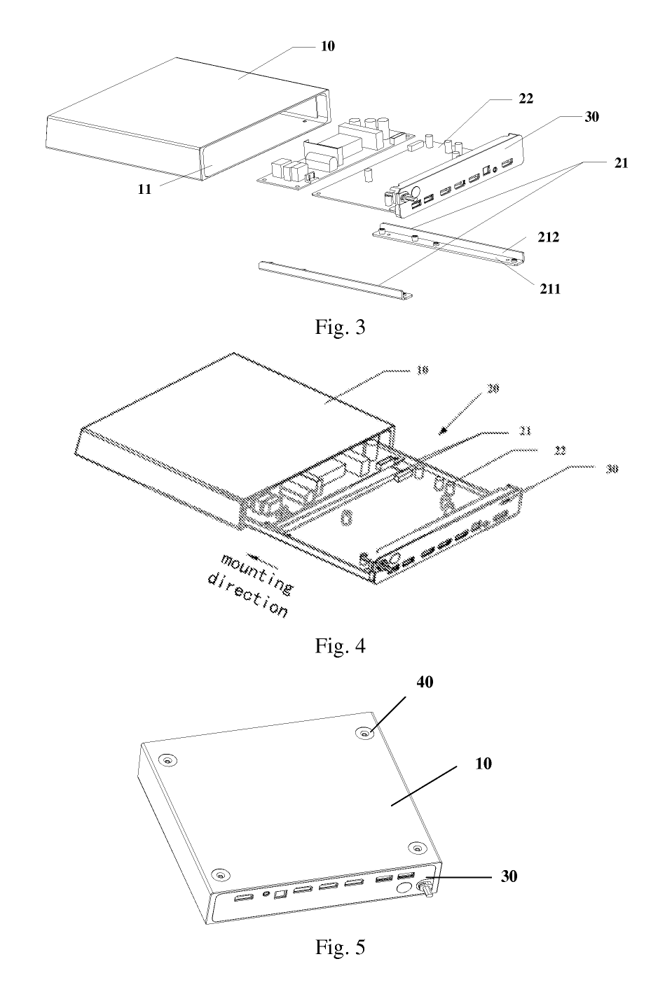

As shown in FIGS. 3, 4 and 5, FIG. 3 is an exploded schematic view of a television box according to an embodiment of the present invention; FIG. 4 is a schematic view of the television box of FIG. 3 which is being assembled; FIG. 5 is a schematic view of the television box of FIG. 4 which has been assembled.

As shown in FIG. 4, the television box comprises: a tubular outer housing 10 which has an opening at one end thereof and defines a receiving chamber 11 therein; and a slide assembly 20 which is slidably received in the receiving chamber 11 of the tubular outer housing 10 through the opening at the one end of the tubular outer housing 10.

As shown in FIG. 3, the slide assembly 20 comprises: a supporting assembly 21 which is slidably connected with an inner sidewall of the tubular outer housing 10, an electronic component board 22 fixed on the supporting assembly, and a rear end cover 30 fixed on the supporting assembly 21 and used for covering the opening of the tubular outer housing 10.

In the above embodiment, the outer housing 10 is formed as an integrated structure, the formed outer housing 10 has a receiving chamber 11 and the entire outer housing 10 is formed in a structure which has a cross section of a “□” shape. The electronic component board 22 is fixed on the supporting assembly 21 and is placed in the receiving chamber 11 by a slidable connection between the supporting assembly 21 and the outer housing 10. The entire supporting strength of the television box is increased by the integrated structure of the outer housing. Specifically, the outer housing 10 may be formed by pressing a sectional aluminum material.

The electronic component board 22 may comprise a main board and a power board. Of course, the electronic component board 22 is not limited to the main board and the power board, it may be any other board containing electronic components, disposed in the television box.

Continuing to refer to FIG. 3, the supporting assembly comprises: two slide rails 21a, 21b arranged opposite to each other. Specifically, each slide rail has an L-shape structure comprising a first folding part 211 and a second folding part 212. Two sides of the electronic component board 22 are fixed on the first folding parts 211 of the two slide rails 21a, 21b, respectively. With this configuration, two sides of the electronic component board 22 are fixed on the opposing first folding parts 211 of the two slide rails 21a, 21b, respectively, the electronic component board 22 is used as a structural part connecting the two slide rails 21, so that the two slide rails 21a, 21b are able to form a stable structure, and thus the electronic component board 22 may be supported by the slide rails 21a, 21b to slide stably while the slide assembly 20 is placed into the receiving chamber 11.

Specifically, as shown in FIGS. 3 and 4, taking the direction of the television box in FIGS. 3 and 4 as an example, the first folding part 211 has a horizontal surface while the second folding part 212 has a vertical surface. During the specific assembling process, the first folding part 211 is used as a connecting structure connecting the electronic component board 22, the second folding part 212 and first folding part 211 form an L-shape structure, so that the supporting strength of the slide rails 21a, 21b is increased and the deformation thereof may be avoided.

According to an embodiment, in order to increase the stability of the sliding movement of the supporting assembly in the receiving chamber, a positioning groove is provided in a sidewall of the receiving chamber and a positioning protrusion which slidably engages the positioning groove is provided on the supporting assembly.

According to another embodiment, a positioning protrusion is provided on a sidewall of the receiving chamber and a positioning groove which slidably engages the positioning protrusion is provided in the supporting assembly.

According to the above embodiments, the sliding direction of the supporting assembly is effectively defined by the slidable fit between the positioning groove and the positioning protrusion; meanwhile, the electronic components on the electronic component board are prevented from collision while the supporting assembly is entering the receiving chamber and thus the security of the electronic component board is increased.

Specifically, when the supporting assembly has slide rails, a positioning protrusion is provided on a sidewall of the tubular outer housing and a positioning groove which slidably engages the positioning protrusion is provided in the supporting assembly, there are two positioning grooves which are provided in the two slide rails, respectively.

Alternatively, when a positioning groove is provided in a sidewall of the receiving chamber and a positioning protrusion which slidably engages the positioning groove is provided on the supporting assembly, there are two positioning protrusions which are provided on the two slide rails, respectively. More specifically, the two positioning grooves or protrusions are provided in or on the first or second folding parts of the two slide rails, respectively.

To facilitate understanding, the above embodiments will be described in details with reference to the accompanying drawings.

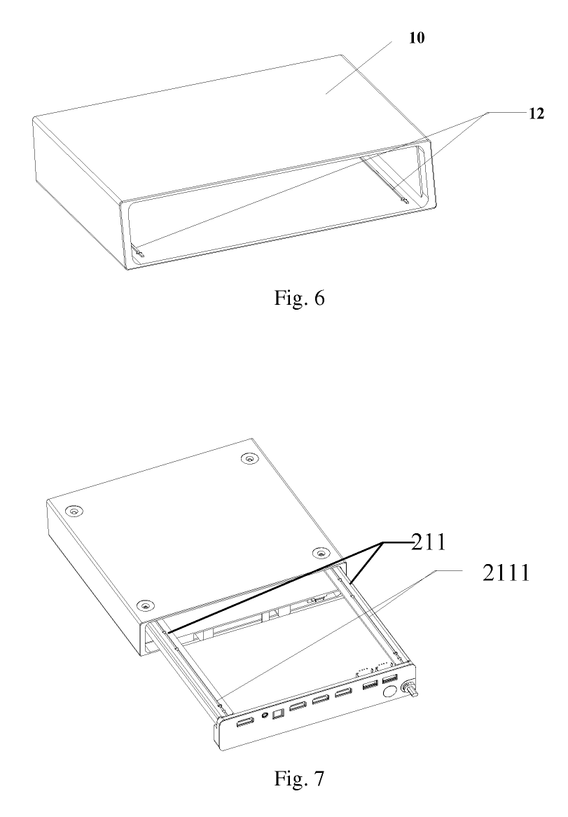

According to an embodiment, as shown in FIGS. 6 and 7, positioning protrusions 12 are provided a sidewall of the receiving chamber 11, respectively, and positioning grooves 2111 are provided in the supporting assembly 21. If the supporting assembly 21 has two slide rails, two positioning grooves 2111 are provided in the two slide rails, respectively. Specifically, if the slide rail has a first folding part 211, the positioning groove 2111 is provided in the first folding part 211.

It should be noted that, the positions of the positioning protrusions 12 are not limited to the positions shown in FIG. 6 (two positioning protrusions 12 are provided on one sidewall of the receiving chamber 11) and may also be arranged in other arrangements. For example, two positioning protrusions are provided on two opposite sidewalls of the receiving chamber, respectively. In that case, two positioning grooves are provided in the second folding parts of the two slide rails, respectively, which is based on the same principle as the above embodiments and is omitted here.

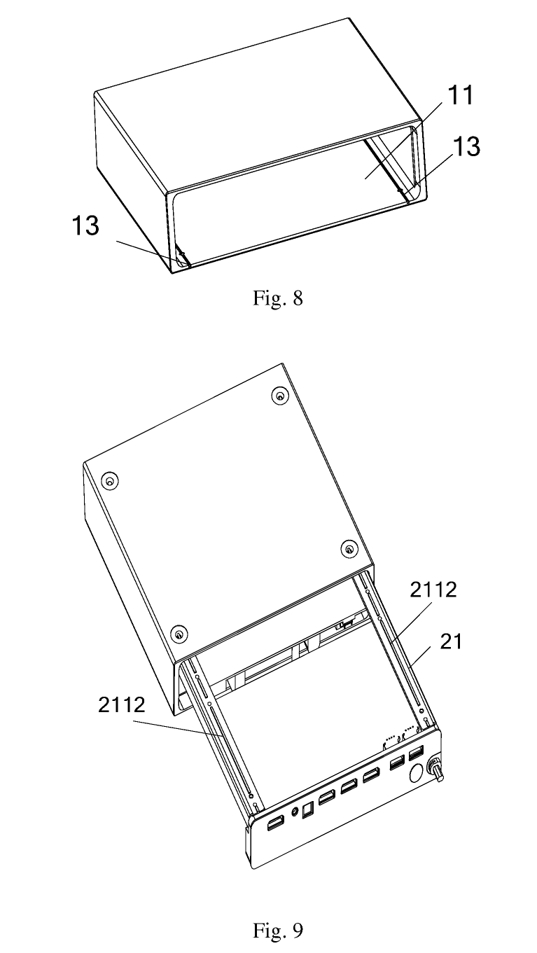

According to another embodiment, as shown in FIGS. 8 and 9, positioning grooves 13 are provided in a sidewall of the tubular housing 10 and positioning protrusions 2112 which slidably engages the positioning grooves 13 are provided in the supporting assembly 21. If the supporting assembly 21 has two slide rails, there are two positioning protrusions 2112 which are provided on the two slide rails, respectively. Specifically, if the slide rail 21 has a first folding part 211 and a second folding part 212, the two positioning protrusions 2112 are provided on the two first folding parts 211 of the two slide rails, respectively.

It should be noted that, the positions of the positioning grooves 13 are not limited to the positions shown in FIG. 8 (both positioning grooves 13 are provided in one sidewall of the receiving chamber 11) and may also be arranged in other arrangements. For example, two positioning grooves are provided in two opposite sidewalls of the receiving chamber 11, respectively. In that case, two positioning protrusions are provided on the second folding parts of the two slide rails, respectively. By using such structure, the positioning of the supporting assembly during sliding movement may also be realized and the stability of sliding movement may be increased.

It should be noted that, the slidable fit between the receiving chamber and the supporting assembly according to the embodiments of the present invention is not limited to the above cases, and any other structure which can realize the sliding movement of the supporting assembly in the receiving chamber may also be applied in the embodiments of the present invention.

During the specific assembling process, various connecting structures may be used to connect the electronic component board 22 with the slide rail 21.

According to an example, a first folding part 211 of the slide rail is fixedly connected with the electronic component board 22 by a snap-fit structure. Specifically, a plurality of first snapping members are provided on the first folding part 211 of each slide rail, and a plurality of second snapping members engagable with the plurality of first snapping members are provided in the electronic component board 22. Alternatively, a plurality of second snapping members are provided in the first folding part 211 of each slide rail, and a plurality of first snapping members which correspond to the plurality of second snapping members respectively are provided on the electronic component board 22. When being assembled, the electronic component board 22 is fixed on the slide rail through the engagement between the first snapping members and the second snapping members, so that the fixed connection between the supporting assembly 21 and the electronic component board 22 is realized, and it is convenient to assemble the entire slide assembly 20 by using the above connecting structure.

According to another example, the first folding part 211 is fixedly connected with the electronic component board 22 via an individual connecting device. Any commonly used connecting device may be used to connect the two parts. The connecting device may be a bolt or screw. Specifically, a plurality of protrusions are provided on the first folding part 211 and each protrusion is provided with a threaded hole; through holes are provided in the electronic component board 22, thus the electronic component board 22 is fixedly connected with the first folding part 211 together by screwing the bolt or screw through the through hole of the electronic component board 22 into the thread hole disposed in the protrusion of the first folding part 211 .

It should be noted that, the connecting structure between the electronic component board 22 and the slide rail 21 in the television box is not limited to the above connecting structures described in the above embodiments, any other connecting structure which can realize the fixed connection between the two parts may also be applied in the embodiments of the present invention.

According to an embodiment, the outer housing 10 as shown in FIG. 4 may have two openings. In this case, the television box may also comprise a front end cover (not shown). Specifically, the front end cover is mounted on the outer housing 10 for example in a snap-fit manner and used for covering one opening while the rear end cover 30 is used for covering the other opening.

According to an embodiment, in the television box as shown in FIG. 4, the slide assembly 20 and the outer housing 10 are fixed together via a connecting member. Specifically, after the rear end cover 30 covers the opening of the receiving chamber 11, the supporting assembly 21 and the outer housing 10 are fixed together via a connecting member.

Specifically, when the slide assembly 20 is sliding toward the receiving chamber 11, the rear end cover 30 is fixed on the supporting assembly 21 and slides along with the supporting assembly 21. When the rear end cover 30 covers the opening, the slide assembly 20 has been assembled in position; at this time, the supporting assembly 21 and the outer housing 10 are fixed together via a connecting member, so that the stability of the entire device after being assembled is increased.

In order to facilitate positioning during the sliding movement, a stopper may be provided on the tubular outer housing. When the slide assembly slides to a predefined position, the stopper may prevent the slide assembly from sliding further. For example, the length of the positioning protrusion 12 disposed on the sidewall of the tubular outer housing 10 is determined such that the entire slide assembly 20 is assembled in position when the supporting assembly presses against an end of the positioning protrusion 12; at this time, the rear end cover 30 just covers the opening of the receiving chamber 11. Alternatively, a positioning protrusion 12 which fits with the rear end cover 30 may be provided on the sidewall of the tubular outer housing 10, such that the entire slide assembly 20 is assembled in position and the rear end cover 30 covers the opening of the receiving chamber 11 when the rear end cover 30 presses against the positioning protrusion 12.

According to an embodiment, the outer housing 10 and the supporting assembly 21 as shown in FIG. 4 are connected together via a connecting member. Specifically, the connecting member is a bolt or a screw, a stepped hole is provided in the outer housing 10 for passing the bolt or screw, and a threaded hole which matching the stepped hole is provided in the supporting assembly. A portion of the stepped hole having a larger diameter is located on an outer side of the outer housing 10. When the supporting assembly slides to a predefined position, the outer housing 10 and the supporting assembly are fixedly connected together by the engagement between the bolt or screw passing through the stepped hole and the threaded hole and the cap of the bolt or screw is located in the portion of the stepped hole having larger diameter. Specifically, a plurality of stepped holes are provided in the outer housing 10, the portions (holes) of the stepped holes having larger diameter are located on an outer side of the outer housing 10 (i.e. a side facing away from the receiving chamber 11) and the portions (holes) of the stepped holes having smaller diameter are located on an inner side of the outer housing 10 (i.e. a side facing toward the receiving chamber 11). If the slide assembly is properly assembled in position, the threaded hole in the supporting assembly is aligned with the stepped hole, and the bolt or screw passing through the stepped hole is threadedly connected with the threaded hole. If the bolt or screw is properly mounted in position, the cap of the bolt or screw is located in the portion of the stepped hole having a larger diameter, so that the cap of the bolt or screw is prevented from protruding from the outer housing 10.

As shown in FIGS. 5 and 7, according to an embodiment, there are four stepped holes which are located at four corners of the outer housing 10 respectively, and an antislip pad 40 is provided in each of stepped holes to cover the cap. The antislip pad 40 is used as a supporting structure of the entire television box and has a slip resistant function to ensure the stability of the television box when it is placed. Further, the appearance of the entire television box is more aesthetically attractive as the antislip pad 40 covers the cap.

Obviously, various modifications and changes may be made to the embodiments of the present invention by those skilled in the art without departing from the spirit and scope of the present invention. Thus, these modifications and changes are intended to be included in the present invention if they fall into the claims of the present invention and the equivalent technology thereof.

1. A television box comprising:
a tubular outer housing which has an opening at one end thereof and defines a receiving chamber therein; and
a slide assembly which comprises an electronic component board and is slidably received in the receiving chamber of the tubular outer housing through the opening.

2. The television box according to claim 1, wherein the slide assembly further comprises:
a supporting assembly which is slidably connected with a sidewall of the tubular outer housing, the electronic component board being fixed on the supporting assembly; and
an end cover which is fixed on the supporting assembly and used for covering the opening of the tubular outer housing.

3. The television box according to claim 2, wherein
a positioning groove is provided in the sidewall of the tubular outer housing and a positioning protrusion which slidably engages the positioning groove is provided on the supporting assembly.

4. The television box according to claim 2, wherein the supporting assembly comprises two slide rails which are arranged opposite to each other.

5. The television box according to claim 4, wherein the television box has a configuration selected from the group consisting of: positioning protrusions are provided on the sidewall of the tubular outer housing and positioning grooves which slidably engages the positioning protrusions are provided in the two slide rails, respectively; and positioning grooves are provided in the sidewall of the tubular outer housing and positioning protrusions which slidably engages the positioning grooves are provided on the two slide rails, respectively.

6. The television box according to claim 5, wherein the slide rail has an L-shape structure comprising a first folding part and a second folding part, and two sides of the electronic component board are fixed on the first folding parts of the two slide rails, respectively.

7. The television box according to claim 6, wherein the positioning grooves or the positioning protrusions are provided in or on the first folding parts or the second folding parts of the two slide rails, respectively.

8. The television box according to claim 7, wherein the first folding part of the slide rail is fixedly connected with the electronic component board by a snap-fit structure.

9. The television box according to claim 7, wherein the first folding part is fixedly connected with the electronic component board through an individual connecting device.

10. The television box according to claim 1, wherein the supporting assembly is fixedly connected with the outer housing through a connecting member.

11. The television box according to claim 10, wherein,
the connecting member is a bolt or screw;
the outer housing is provided with a stepped hole for passing the bolt or screw, the supporting assembly is provided with a threaded hole matching the stepped hole, and a portion of the stepped hole having a larger diameter is located on an outer side of the outer housing; and
the outer housing is fixedly connected with the supporting assembly by engaging the bolt or screw passing through the stepped hole with the threaded hole and a cap of the bolt or screw is located in the portion of the stepped hole having a larger diameter when the supporting assembly slides to a predefined position.

12. The television box according to claim 11, wherein an antislip pad is provided in each stepped hole and covers the cap.

13. The television box according to claim 1, wherein a stopper is provided on the tubular outer housing, and configured to prevent the slide assembly from sliding further when the slide assembly has slid to a predefined position.

14. The television box according to claim 1, wherein the tubular outer housing has another opening at the other end thereof for mounting another end cover.

15. The television box according to claim 2, wherein a positioning protrusion is provided on the sidewall of the tubular outer housing and a positioning groove which slidably engages the positioning protrusion is provided in the supporting assembly.
